(19) United States
(12) Patent Application Publication
(10) Pub. No.: US 2020/0232957 A1
(43) Pub. Date: Jul. 23, 2020

(54) METHOD FOR QUANTIFYING 3,6-ANHYDRO-L-GALACTOSE USING HIGH-PERFORMANCE LIQUID CHROMATOGRAPHY AND DIFFERENTIAL REFRACTOMETRIC DETECTOR

(71) Applicant: Korea University Research and Business Foundation, Seoul (KR)

(72) Inventors: Kyoung Heon KIM, Seoul (KR); Kyung-mun CHO, Seongnam-si (KR); Eun-Ju YUN, Seoul (KR); Dong-Hyun KIM, Busan (KR)

(73) Assignee: Korea University Research and Business Foundation, Seoul (KR)

(21) Appl. No.: 16/630,921

(22) PCT Filed: Jul. 5, 2018
(86) PCT No.: PCT/KR2018/007612

§ 371 Date: Jan. 14, 2020

(30) Foreign Application Priority Data
Jul. 14, 2017 (KR) 10-2017-0089841

(51) Int. Cl. G01N 30/88; G01N 30/86

(52) U.S. Cl. CPC G01N 30/88; G01N 2030/027; G01N 30/86

(57) ABSTRACT

The present invention relates to a method for quantifying 3,6-anhydro-L-galactose using high-performance liquid chromatography and a differential refractometric index detector, whereby L-AHG and D-galactose, which are saccharification products of agarose or agar, can be independently quantified by controlling the separation conditions of the high-performance liquid chromatography/differential refractive index detector, even though the two materials are difficult to separate due to having similar molecular weights and structures.

### BACKGROUND

### 1. Field of the Invention

The present invention relates to a method of quantifying 3,6-anhydro-L-galactose in a monosaccharide mixture of 3,6-anhydro-L-galactose (L-AHG) and D-galactose, which are saccharification products of agarose or agar, by using high-performance liquid chromatography equipped with a refractive index detector.

### 2. Discussion of Related Art

Typical examples of cell wall polysaccharides constituting red algae are cellulose, xylan, mannan, agar, and carrageenan. The main component of viscous polysaccharides that constitute the outer layer and cell space of red algae cell walls is agar. Agar is a mixture of agarose (about 80%) and agaropectin (about 20%), which are not polysaccharides formed of monosaccharides. The proportion of agarose in agar polysaccharides varies depending on the species of seaweed and accounts for 80% on average.

Agar polysaccharides are polymers in which two monosaccharides, i.e., D-galactose and 3,6-anhydro-L-galactose (L-AHG) are alternately bound via α-1,3-linkage and β-1,4-linkage. Among these, 3,6-anhydro-L-galactose has been reported to have various physiological activities such as antioxidant, anti-inflammatory, whitening and anticancer effects, and can be widely used in food and pharmaceutical industries as food and pharmaceutical materials. In addition, 3,6-anhydro-L-galactose, which has been registered as a cosmetic raw material, can be applied to cosmetic materials as a substance with whitening functionality.

Therefore, there is currently a need to develop a method of producing 3,6-anhydrogalactose having various physiological activities through an enzymatic reaction and a method of quantifying the same. As a conventionally known method for enzymatic hydrolysis of agarose, there is a method of, first, producing a neoagarooligosaccharide from an agarose polymer through the reaction of Aga16B, which is an endo-type β-agarase, producing neoagarobiose, which is a disaccharide, through the reaction of Aga50D, which is an exo-type β-agarase, and finally producing L-AHG and D-galactose, which are monosaccharides, through a neoagarobiose hydrolase (NABH) reaction. L-AHG and D-galactose are quantified through a color reaction using coloring reagents of resorcinol and anthrone. However, these methods are disadvantageous in that sample treatment is complicated, preparation time for analysis is long, and accuracy is low (Yaphe W. (1960). Analytical Chemistry, 32 (10), 1327-1330; Matsuhiro B et al. (1983). Carbohydrate Research, 118, 276-279). As another method, there is an analysis method using the time difference in the retention of individual compounds inside a column through gas chromatography, which is widely used for the separation analysis of mixtures (Jol C N et al. (1999). Analytical Biochemistry, 268 (2), 213-222; Hama Y et al. (1998). Analytical Biochemistry, 265 (1), 42-48; Ye F T et al. 2006. Phytochemical Analysis, 17 (6), 379-383). However, the above-described documents do not describe the separation of monosaccharides and polysaccharides or direct analysis of L-AHG and D-galactose from among monosaccharides, and describe that, since these have similar molecular weights and structures, it is difficult to independently quantify two materials when mixed. As a patent document that describes independent quantification of these materials, there is Korean Patent Publication No. 2011-0072958 which discloses “Enzymatic production of 3,6-anhydro-L-galactose and galactose from agar using crude enzymes of Saccharophagus degradans 2-40 and the quantitative analytical method for 3,6-anhydro-L-galactose”. However, this method is disadvantageous in that it is difficult to know the exact derivatization rate of a sample by an analytical method using gas chromatography-mass spectrometry, exposure to heat generated during derivatization leads to denaturation of L-AHG, which is weak in thermal stability, making it difficult to measure the accurate amount of L-AHG, and expensive mass spectrometers and expensive samples for derivatization should be used.

### SUMMARY OF THE INVENTION

An object of the present invention is to provide a method of quantifying 3,6-anhydro-L-galactose from a mixture of monosaccharides produced in the saccharification of agarose or agar.

To achieve the above-described object, the present invention provides a method of quantifying 3,6-anhydro-L-galactose, the method including quantifying 3,6-anhydro-L-galactose in an analytical sample including galactose and 3,6-anhydro-L-galactose by using high-performance liquid chromatography equipped with a refractive index detector, wherein the quantification of the 3,6-anhydro-L-galactose by using high-performance liquid chromatography equipped with a refractive index detector uses, as a mobile-phase solvent, a mixed solvent of 15% (v/v) to 100% (v/v) of acetonitrile and 0.005 M to 0.015 M of trifluoroacetic acid and is performed at a flow rate of 0.1 mL/min to 0.6 mL/min and a column temperature of 25° C. to 45° C.

According to the present invention, although it is difficult to separate L-AHG and D-galactose, which are saccharification products of agarose or agar, due to similar molecular weights and structures thereof, the two materials can be independently quantified by controlling separation conditions of high-performance liquid chromatography equipped with a refractive index detector.

### BRIEF DESCRIPTION OF THE DRAWINGS

FIG. 1 illustrates the results of analyzing a mixture of 3,6-anhydro-L-galactose and D-galactose by high-performance liquid chromatography using a size exclusion column equipped with a refractive index detector.

FIG. 2 illustrates the results of performing SDS-PAGE on expressed and purified proteins after the β-agarases Aga16B and Aga50D and a neoagarobiose hydrolase (NABH), which were derived from Saccharophagus degradans 2-40T, were introduced into Escherichia coli BL21(DE3) using a pET21a vector.

FIG. 3 illustrates TLC analysis results showing the production of L-AHG and D-galactose from agarose through a three-step enzymatic reaction.

FIG. 4 illustrates the results of confirming the separation of two monosaccharides, i.e., L-AHG and D-galactose at different concentrations of acetonitrile, which is a mobile-phase solvent.

FIG. 5 illustrates the results of confirming the retention time of two monosaccharides, i.e., L-AHG and D-galactose at different flow rates of acetonitrile, which is a mobile-phase solvent.

FIG. 6 illustrates the results of confirming the retention time of two monosaccharides, i.e., L-AHG and D-galactose at different HPX-87H column temperatures.

FIG. 7 illustrates the standard curves of two standard materials, i.e., D-AHG and D-Gal under high-performance liquid chromatography establishment conditions.

### DETAILED DESCRIPTION OF EXEMPLARY EMBODIMENTS

Hereinafter, the configuration of the present invention will be described in detail.

The present invention relates to a method of quantifying 3,6-anhydro-L-galactose, the method including quantifying 3,6-anhydro-L-galactose in an analytical sample including galactose and 3,6-anhydro-L-galactose by using high-performance liquid chromatography equipped with a refractive index detector, wherein the quantification of the 3,6-anhydro-L-galactose by using high-performance liquid chromatography equipped with a refractive index detector uses, as a mobile-phase solvent, a mixed solvent of 15% (v/v) to 100% (v/v) of acetonitrile and 0.005 M to 0.015 M of trifluoroacetic acid and is performed at a flow rate of 0.1 mL/min to 0.6 mL/min and a column temperature of 25° C. to 45° C.

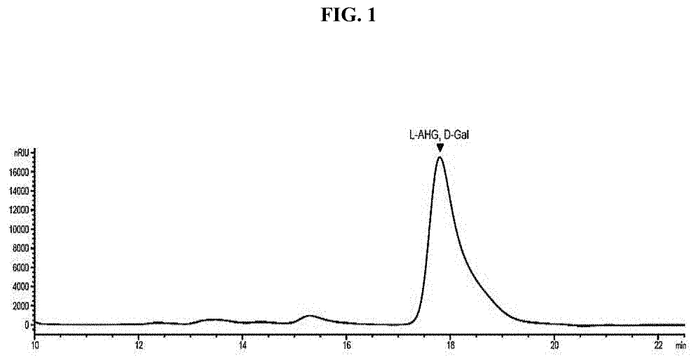

Among saccharification products of agarose or agar, 3,6-anhydro-L-galactose (hereinafter referred to as L-AHG) and D-galactose have similar molecular weights and structures, and thus the peaks of L-AHG and D-galactose are not significantly separated in high-performance liquid chromatography using a size exclusion column equipped with a refractive index detector (see FIG. 1).

Therefore, according to the present invention, to independently quantify only L-AHG in a mixture of monosaccharides, i.e., L-AHG and D-galactose, among saccharification products of agarose or agar without derivatization of a sample (the mixture of L-AHG and D-galactose), analysis conditions of high-performance liquid chromatography equipped with a refractive index detector are controlled to thereby quantify L-AHG.

In the method of quantifying L-AHG according to the present invention, the analytical sample may be a sample obtained through saccharification of agarose or agar.

The saccharification of agarose or agar may be performed through enzymatic hydrolysis of pre-treated agarose or agar, or may be performed through enzymatic hydrolysis of agarose or agar without pre-treatment.

When the enzymatic hydrolysis of agarose or agar without pre-treatment is performed, the enzyme may be isolated and purified from a culture of Saccharophagus degradans 2-40T, or may be produced and isolated from strains other than Saccharophagus degradans using genetic engineering recombination technology, by artificial chemical synthesis, or the like.

When using recombination technology, factors used for facilitating conventional recombinant protein expression, e.g., antibiotic resistance genes, or reporter proteins or peptides that may be used for affinity column chromatography may be used, and such technology is within the scope of being easily carried out by those of ordinary skill in the art to which the present invention pertains.

In the present invention, the term “recombinant” used in connection with cells, nucleic acids, proteins, or vectors refers that the cells, nucleic acids, proteins, or vectors are modified by introduction of heterologous nucleic acids or proteins or alteration of innate nucleic acids or proteins, or that the cells are derived from such modified cells. That is, the recombinant cells, for example, express genes which are not found in the cells in an original non-recombinant form, or express original genes which are expressed abnormally upon expression or not expressed at all.

In this specification, the term “nucleic acid” encompasses single- or double-stranded DNAs, RNAs, and chemical variants thereof. The terms “nucleic acid” and “polynucleotide” may be used interchangeably herein. Since the genetic codes are degenerate, one or more codons may be used to encode a specific amino acid, and the present invention encompasses polynucleotides encoding certain amino acid sequences.

The term “introduction” used to describe an insertion of a nucleic acid sequence into cells refers to “transfection,” “transformation,” or “transduction,” and encompasses references to the integration of a nucleic acid sequence into eukaryotic or prokaryotic cells. In this case, the nucleic acid sequence is integrated into the genome (for example, a chromosome, a plasmid, a plastid, or mitochondrial DNA) of a cell, and converted into an autonomous replicon or expressed temporally.

According to one embodiment of the present invention, nucleic acid sequences of Aga16B, which is an endo-type β-agarase, Aga50D, which is an exo-type β-agarase, and a neoagarobiose hydrolase (NABH), which are derived from Saccharophagus degradans 2-40T, are inserted into an expression vector and transformed into E. coli BL21(DE3) to thereby produce recombinant Aga16B, Aga50D and NABH enzymes. Without pretreatment, agarose or agar is used as a substrate and allowed to sequentially react with the recombinant enzymes, thereby preparing an analytical sample including L-AHG and D-galactose. For a specific technique for producing a recombinant enzyme, refer to Korean Patent Publication Nos. 2012-0077339 (2012 Jul. 10), 2010-0040438 (2010 Apr. 20), and 2013-0085017 (2013 Jul. 26).

The sample obtained as above may be a liquid or aqueous sample, but the present invention is not limited thereto.

When the analytical sample is subjected to high-performance liquid chromatography equipped with a refractive index detector, a mixed solvent of 15% (v/v) to 100% (v/v) of acetonitrile and 0.005 M to 0.015 M of trifluoroacetic acid may be used as a mobile-phase solvent. More particularly, a mixed solvent of 20% (v/v) to 60% (v/v) of acetonitrile and 0.007 M to 0.012 M of trifluoroacetic acid, most particularly, a mixed solvent of 20% (v/v) to 40% (v/v) of acetonitrile and 0.01 M of trifluoroacetic acid may be used. When the concentration of acetonitrile is less than 15%, L-AHG and D-galactose are not separated. On the other hand, when the concentration of acetonitrile is greater than 40%, although L-AHG and D-galactose may be significantly separated, it is preferable to use acetonitrile at a concentration of 20% (v/v) to 40% (v/v) in consideration of the allowable concentration of a column.

In addition, the retention time of L-AHG and D-galactose signals is inversely proportional to the flow rate, and the flow rate may range from 0.1 mL/min to 0.6 mL/min. When the flow rate exceeds 0.6 mL/min, the pressure of a column exceeds 50 atm, and thus the column may not withstand the pressure, and when the flow rate is less than 0.1 mL/min, the analysis time may be increased.

The column temperature is inversely proportional to the column pressure and may range from 25° C. to 45° C. When the column temperature exceeds 45° C., the column may be damaged due to the volatility of trifluoroacetic acid as a mobile-phase solvent, and when the column temperature is less than 25° C., the column may be damaged due to increased pressure thereof and the column is easily exposed to contamination.

The content of 3,6-anhydro-L-galactose in the analytical sample may be calculated using a quantitative curve of Equation 1 below, which is obtained by calculating an area value according to concentration of the retention time of a standard material under the same analysis conditions by using high-performance liquid chromatography equipped with a refractive index detector.

y=361648x−5644.4 [Equation 1]

wherein, x is the concentration of 3,6-anhydro-L-galactose, and y is the area value per concentration of retention time.

Hereinafter, the present invention will be described in further detail with reference to the following examples, but these examples are not intended to limit the scope of the present invention.

### EXAMPLE

### <Example 1> Production of Recombinant Aga16B, Aga50D and NABH Enzymes

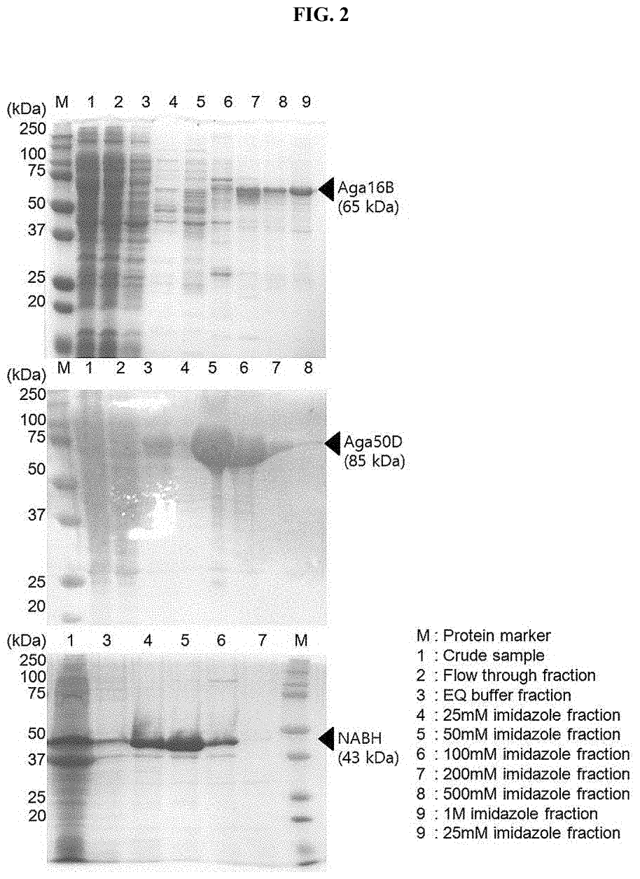

The Aga16B gene, which is an endo-type β-agarase, the Aga50D gene, which is an exo-type β-agarase, and the NABH gene, which is a neoagarobiose hydrolase, which were derived from Saccharophagus degradans 2-40T, were introduced into E. coli BL21(DE3) using a pET21a vector. For pre-culture, recombinant E. coli into which each gene was introduced was cultured in 10 mL of LB broth containing 100 μg/mL of ampicillin in a 50 mL-conical tube at 37° C. for 9 hours. Subsequently, 10 mL of a pre-culture solution was inoculated into 1 L of the main culture solution having the same medium composition, and then when absorbance at 600 nm reached a mid-exponential stage (absorbance=0.4 to 0.6) which was measured using a spectrophotometer, 0.1 mM isopropyl-beta-D-thiogalactopyranoside (IPTG) was added and induced at 16° C. for 16 hours. The cell culture solution was then transferred to a 500 mL-tube and centrifuged at 4° C. and 10,000 rpm for 20 minutes to harvest cells. To prevent protein denaturation, the cells collected in 30 mL of Tris buffer (20 mM Tris-HCl, pH 7.4) were resuspended, and the cells were disrupted using a sonicator (cell lysis). Thereafter, the cells were centrifuged at 4° C. and 16,000 rpm for 1 hour. Proteins were purified using a HiTrap™ column (5 mL GE Health Care), and then the size of each purified protein was determined using a SDS-PAGE gel (see FIG. 2).

A desalting column was used to remove a salt (imidazole) used for protein purification. The concentration of the salt-free recombinant protein enzyme was quantified by BCA assay.

### <Example 2> Enzymatic Reaction of Aga16B, Aga50D, and NABH

For an Aga16B enzymatic reaction, 5% (w/v) of agarose was used as a substrate and a reaction was allowed to occur in 20 mM Tris-HCl buffer (pH 7.4) at 55° C. and 200 rpm for 10 hours.

An Aga50D enzymatic reaction was carried out using a neoagarooligosaccharide, which is an Aga16B enzymatic reaction product, as a substrate at 25° C. and 200 rpm for 24 hours.

Finally, an NABH enzymatic reaction was performed using neoagarobiose, which is an Aga50D enzymatic reaction product, at 30° C. and 200 rpm for 12 hours.

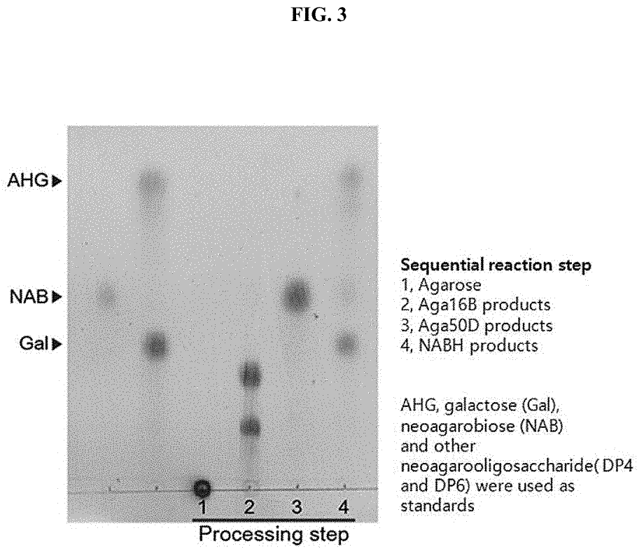

After each enzymatic reaction, the reaction product was analyzed through thin layer chromatography (TLC). TLC assay conditions were as follows: 1 μl of each enzymatic reaction product was loaded onto a silica gel plate as a stationary-phase and the reaction product was developed using n-butanol:ethanol:water=3:1:1 (v/v/v) as a mobile-phase solvent for 1 hour, and then developed color using 10% sulfuric acid in ethanol and 0.2% 1,3-dihydroxynaphthalene in ethanol (see FIG. 3).

As shown in FIG. 2, the agarose substrate was decomposed into a neoagarooligosaccharide through the enzymatic reaction of Aga16B, which is an endo-type β-agarase, and at this time, the main products were neoagarotetraose and neoagarohexaose, corresponding to degree of polymerization (DP) 4 and DP 6. Subsequently, neoagarobiose, which is a disaccharide, was produced through the enzymatic reaction of Aga50D, which is exo-type β-agarase II, and AHG and D-galactose were produced through the NABH enzymatic reaction (see FIG. 3).

### <Example 3> Preparation of Mobile-Phase Solvent and Sample and Device Stabilization for Using High-Performance Liquid Chromatography Equipped with a Refractive Index Detector (HPLC/RID)

As a mobile-phase solvent of high-performance liquid chromatography, 40% (v/v) acetonitrile in 0.01 M TFA was used, and preparation was carried out using the following method. 1.14 mL of trifluoroacetic acid (TFA, Sigma Aldrich) and 400 mL of acetonitrile (ACN, J. T. Baker) were mixed in 598.86 mL of triple distilled water in a 1 L beaker. Subsequently, the resulting solution was sufficiently stirred using a magnetic bar for 3 minutes. A mobile phase was filtered using 0.45 μm nylon membrane filters (GE Healthcare Life Sciences). Through sonication for 90 minutes, air bubbles remaining inside the filtrate were removed.

Sample preparation was as follows. An L-AHG sample having been purified to high purity (>95%) and dried was diluted with water to adjust the amount to 2 mg/mL. At least 45 μl of a sample was prepared by inserting an insert into a vial for high-performance liquid chromatography analysis and preventing air bubbles from entering the inside of the insert. A high-purity (>98.5%) D-Gal reagent was diluted with water to adjust the amount to 2 mg/mL. At least 45 μl of a sample was prepared by inserting an insert into a vial for high-performance liquid chromatography analysis and preventing air bubbles from entering the inside of the insert. 50 μl of 2 mg/mL L-AHG and 50 μl of 2 mg/mL D-Gal were mixed to prepare 1 mg/mL of a mixed sample of D-Gal and L-AHG.

For the stabilization of a high-performance liquid chromatography device, the HPLC device was turned on and connected to a computer, and then the HPLC device equipped with the HPX-87H column was connected to the prepared 40% (v/v) acetonitrile in 0.01 M TFA. The column temperature and the temperature of a refractive index detector (RID) were adjusted in accordance with conditions at a flow rate of 0.1 mL/min. The flow rate was increased by 0.1 mL/min every stabilization after the pressure, diode balance, and RI signals were sufficiently stabilized to meet final flow rate conditions.

### <Example 4> Establishment of Separation Conditions of Two Monosaccharides, L-AHG and D-Galactose Using High-Performance Liquid Chromatography Equipped with a Refractive Index Detector

To find the conditions under which two monosaccharides are separable through the most economical solvent consumption, an experiment was conducted by varying the concentration of mobile-phase acetonitrile, such as at a concentration of 10% (v/v), 20% (v/v), 40% (v/v), or 60% (v/v).

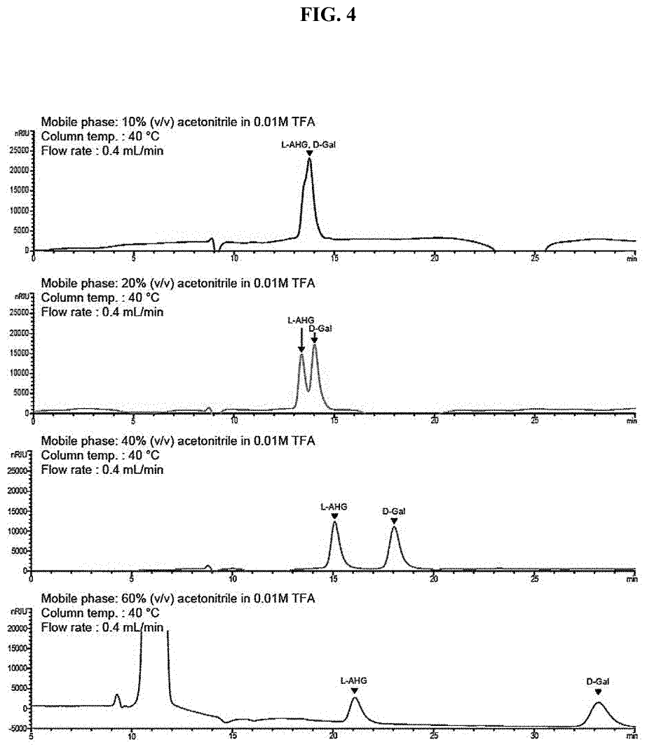

As illustrated in FIG. 4, it was confirmed that separation had already been started at a measured concentration of acetonitrile of 20% and L-AHG and D-galactose were significantly separated at a concentration of acetonitrile of 40% or 60%. However, the concentration of acetonitrile recommended for the column of the present example is a maximum of 40%. Therefore, the most suitable analytical method includes a 40% acetonitrile condition.

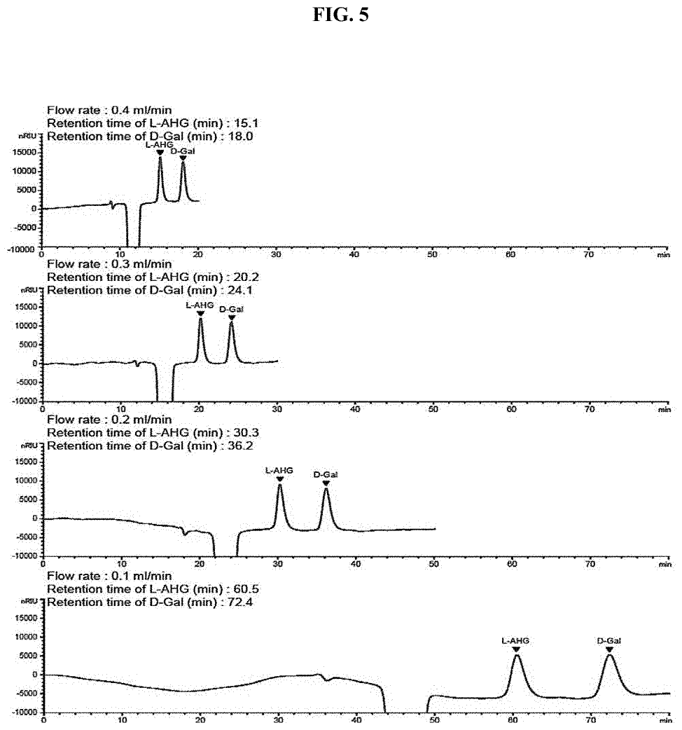

Next, when a mobile phase in the column was flowed at various different flow rates of 0.1 mL/min, 0.2 mL/min, 0.3 mL/min, and 0.4 mL/min, the retention time of L-AHG and D-galactose signals was shown to be inversely proportional to the flow rate (see FIG. 5). It can be seen that, when flowing the same mobile phase, peaks were significantly separated even at a flow rate of 0.4 mL/min and a short retention time is advantageous in terms of a reduction in analysis time of the sample. Under conditions of 0.5 mL/min or greater, the pressure of the column exceeds 50 atm, and thus the column may not withstand the pressure. Therefore, an analysis method within the fastest time is when the column flow rate is 0.4 mL/min.

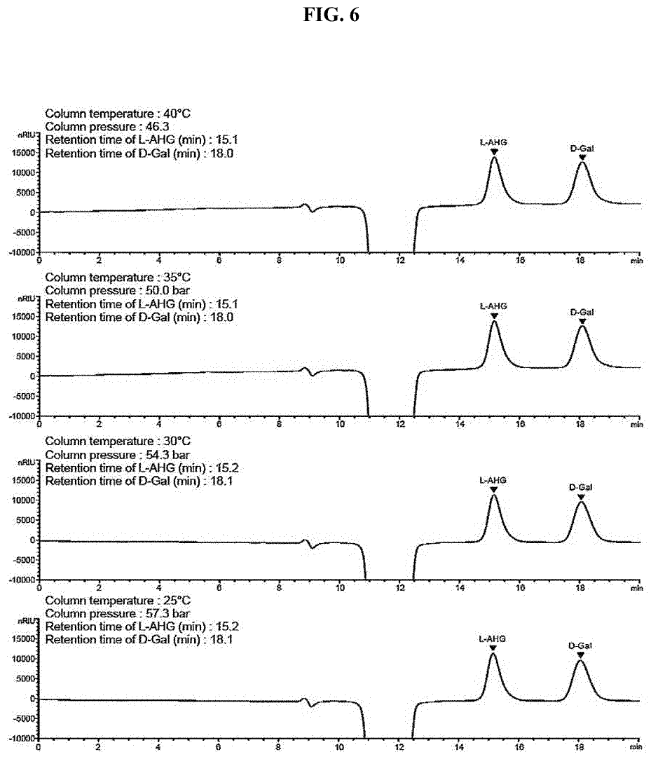

Next, when the temperature of the HPX-87H column was changed to 25° C., 30° C., 35° C., and 40° C., the retention time of L-AHG was the same as that of D-galactose (see FIG. 6). However, as the column temperature decreases, the pressure applied to the column increases in inverse proportion thereto, and when the column temperature exceeds 45° C., the pressure of the column may be increased due to the volatility of trifluoroacetic acid, and thus the optimum temperature of the HPX-87H column is 40° C.

### <Example 5> Standard Curves of Two Monosaccharides, 3,6-Anhydro-D-Galactose and D-Galactose Under Optimal Conditions Using High-Performance Liquid Chromatography Equipped with a Refractive Index Detector

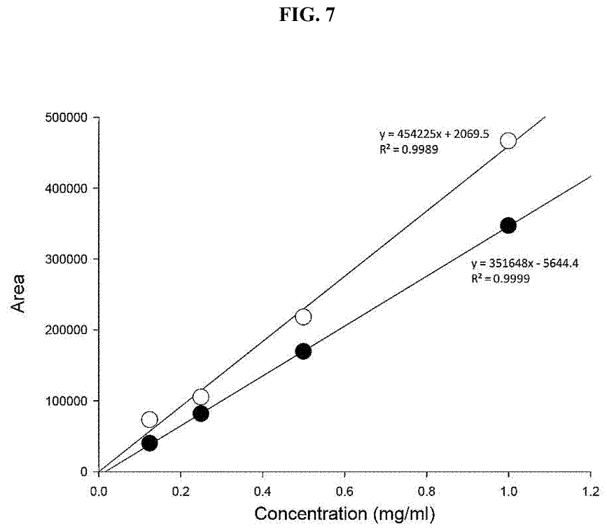

After stabilizing a refractive index detector (RID) having a flow rate of 0.4 mL/min, a HPX-87H column temperature of 40° C., and a temperature of 45° C., 300 μl of D-AHG and D-galactose, which are standard materials, in distilled water at a concentration of 0.125 mg/mL, 0.25 mg/mL, 0.5 mg/mL, or 1 mg/mL was prepared in high-performance liquid chromatograph vials. The device was set in accordance with the operation order, and then 20 μl of the prepared sample was injected into the HPLC/RID device. Information about the retention time of sample signals according to concentration of the standard materials from the corresponding mobile phase and column was recorded and areas per concentration of the specific retention time of the standard materials were calculated, thereby creating quantitative curves (see FIG. 7)

The present invention may be applied to the quantification of L-AHG and D-galactose, which are saccharification products of agarose or agar.

What is claimed is:

1. A method of quantifying 3,6-anhydro-L-galactose, the method comprising quantifying 3,6-anhydro-L-galactose in an analytical sample comprising galactose and 3,6-anhydro-L-galactose by using high-performance liquid chromatography equipped with a refractive index detector,
wherein the quantifying of the 3,6-anhydro-L-galactose by using high-performance liquid chromatography equipped with a refractive index detector uses, as a mobile-phase solvent, a mixed solvent of 15% (v/v) to 100% (v/v) of acetonitrile and 0.005 M to 0.015 M of trifluoroacetic acid and is performed at a flow rate of 0.1 mL/min to 0.6 mL/min and a column temperature of 25° C. to 45° C.

2. The method of claim 1, wherein the analytical sample is a sample obtained through the saccharification of agarose or agar.

3. The method of claim 1, wherein the analytical sample is an aqueous sample.

4. The method of claim 1, wherein the mobile-phase solvent is a mixed solvent of 20% (v/v) to 40% (v/v) of acetonitrile and 0.01 M of trifluoroacetic acid.

5. The method of claim 1, wherein a content of 3,6-anhydro-L-galactose in the analytical sample is calculated using a quantitative curve of Equation 1 below, the quantitative curve being obtained by calculating an area value per concentration of retention time of a standard material under the same analysis conditions by using high-performance liquid chromatography equipped with a refractive index detector:
y=361648x−5644.4 [Equation 1]
wherein, x is a concentration of 3,6-anhydro-L-galactose, and y is an area value per concentration of retention time.
